(19) United States
(12) Patent Application Publication
(10) Pub. No.: US 2019/0164420 A1
(43) Pub. Date: May 30, 2019

(54) METHOD FOR COORDINATING DISTANCES WITHIN A VEHICLE CONVOY

(71) Applicant: Robert Bosch GmbH, Stuttgart (DE)

(72) Inventors: Hauke Wendt, Ditzingen (DE); Sergey Chirkov, Kornwestheim (DE)

(21) Appl. No.: 16/164,927

(22) Filed: Oct. 19, 2018

(30) Foreign Application Priority Data
Nov. 24, 2017 (DE) 102017221104.0

(51) Int. Cl. G08G 1/0967; G05D 1/02; G01C 21/36; G08G 1/0962

(52) U.S. Cl. CPC G08G 1/096725; G05D 1/0291; G01C 21/3691; G05D 2201/0213; G08G 1/096775; G08G 1/09626; G08G 1/096791

(57) ABSTRACT

A method for coordinating at least one distance between at least two autonomous or semi-autonomous vehicles in a group of vehicles, at least one on-ramp and/or exit ramp of a road traveled by the vehicles in an area ahead of the group of vehicles being registered, a situation-dependent optimal distance for passing the on-ramp and/or exit ramp between the vehicles being ascertained, a distance between the vehicles being adapted to the situation-dependent optimal distance between the vehicles before the on-ramp and/or the exit ramp is reached, the on-ramp and/or the exit ramp being passed with the ascertained situation-dependent optimal distance between the vehicles, a situation-dependent optimal distance between the vehicles being re-ascertained after having passed the on-ramp and/or exit ramp, and the distance between the vehicles being adapted to the re-ascertained situation-dependent optimal distance between the vehicles after having passed the on-ramp and/or exit ramp.

### CROSS REFERENCE

The present application claims the benefit under 35 U.S.C. § 119 of German Patent Application No. DE 102017221104.0 filed on Nov. 24, 2017, which is expressly incorporated herein by reference in its entirety.

### FIELD

The present invention relates to a method for coordinating at least one distance between at least two autonomous or semi-autonomous vehicles in a group of vehicles.

### BACKGROUND INFORMATION

To make the fuel consumption of commercial vehicles more economical and environmentally friendly, manufacturers at present are working on approaches for a so-called “platooning” or grouping of multiple commercial vehicles into a vehicle convoy or a group of vehicles. For this purpose, multiple commercial vehicles, such as trucks, drive in an electronically coupled manner closely behind a lead vehicle to benefit from the slipstream of the preceding vehicles and be able to save fuel. However, this approach is problematic in traffic since the safety of other road users may be impaired by an effective slipstream driving of the commercial vehicles. In particular, it must be ensured at on-ramps and exit ramps on expressways that other road users are able to cut in and pull out between the platoon vehicles. For this reason, only a fixed maximum number of platoon users is provided with present approaches, with simultaneously relatively large minimum distances within the vehicle convoy. The distance between the platoon users is designed to remain consistent in such a way that other road users may cut in between the platoon vehicles at any time, even if the traffic volume is low, for example, or the situation does not require this. In current methods, the actual fuel savings thus falls far short of the savings which are theoretically possible with an optimal utilization of the slipstream of the respective preceding commercial vehicle.

### SUMMARY

An object of the present invention is to provide a method for coordinating at least one distance between at least two autonomous or semi-autonomous vehicles in a group of vehicles or a vehicle convoy, in which the distance between the vehicles of a group of vehicles is adapted as a function of the situation, and the creation of vehicle convoys having an arbitrary number of vehicles is made possible.

This object is achieved with the aid of the example embodiments described herein. Advantageous embodiments of the present invention are described herein.

According to one aspect of the present invention, a method for coordinating at least one distance between at least two autonomous or semi-autonomous vehicles in a group of vehicles is provided. For this purpose, at least one on-ramp and/or exit ramp of a road traveled by the at least two vehicles in an area ahead of the group of vehicles is registered. A situation-dependent optimal distance for passing the on-ramp and/or exit ramp between the at least two vehicles is ascertained. Thereafter, the distance between the at least two vehicles is adapted to the situation-dependent optimal distance between the at least two vehicles before the on-ramp and/or the exit ramp is reached. The on-ramp and/or the exit ramp is/are passed with the ascertained situation-dependent optimal distance between the at least two vehicles. Another ascertainment of a situation-dependent optimal distance between the at least two vehicles takes place for a segment after the on-ramp and/or exit ramp has been passed. Thereafter, another adaption of the distance between the at least two vehicles is carried out until the re-ascertained situation-dependent optimal distance between the at least two vehicles is reached after having passed the on-ramp and/or exit ramp.

When passing the on-ramp and/or the exit ramp on roads, such as rural roads, federal highways or expressways, electronically coupled vehicle convoys or groups of vehicles may represent a safety problem. Passing means that the vehicle convoys do not use the on-ramp and/or the exit ramp themselves, but remain on the road they are traveling on and pass the on-ramp and/or the exit ramp. In areas before and next to the on-ramp and/or the exit ramp, frequent cutting in of other road users between the individual vehicles of the vehicle convoy is to be expected, so that optimally a larger distance has to be maintained between the vehicles of the group of vehicles in these areas. On route sections having no on-ramps and/or exit ramps, the distance between the vehicles of the vehicle convoy may optimally be reduced to ensure a preferably economical utilization of the slipstream of the preceding vehicle within the group of vehicles. A situation-dependent optimal distance between the vehicles is thus variable and to be adapted, depending on the requirements of the route section, in such a way that other road users in the area of on-ramps and/or exit ramps are offered sufficient distance between the vehicles of the group of vehicles for cutting in, and preferably economical driving in the slipstream of the preceding vehicle of the vehicle convoy is made possible in areas having no on-ramps and/or exit ramps. For this purpose, the presence of an on-ramp and/or an exit ramp and the start and the end of an acceleration lane of an on-ramp or of a deceleration lane of an exit ramp may be ascertained on the planned or current route section. For each on-ramp and/or exit ramp, it is possible to determine both a situation-dependent optimal distance at the start and after the end of the on-ramp and/or exit ramp, and the distance before the start and after the end of the on-ramp, at which an adaptation of the distance between the vehicles of the vehicle convoy may be initiated to economically and safely achieve the situation-dependent optimal distance before the start of the on-ramp and/or exit ramp and after the end of the on-ramp and/or exit ramp. The situation-dependent optimal distance between the vehicles of the vehicle convoy for the planned passing of the on-ramp and/or the exit ramp may be ascertained in a timely manner and with a sufficient distance before the start of an acceleration lane or a deceleration lane. The ascertainment of the situation-dependent optimal distance should take place at such a sufficient distance, both in terms of time and location, from the on-ramp and/or the exit ramp situated ahead of the vehicle convoy that all vehicles of the vehicle convoy have sufficient time to adapt the distances between the vehicles and achieve the optimal distance for the respective situation. The setting or adaptation of the distance between the vehicles of the vehicle convoy preferably takes place on a transition segment. The transition segment is used to set the distances of the vehicles to the situation-dependent optimal ascertained distances. A length and a start of the transition segment may be defined by various factors, such as mass and length, number of the vehicles in the vehicle convoy and a speed of the vehicles. The vehicles of the vehicle convoy preferably have the situation-dependent optimal distance from one another after having covered the transition segment. The transition segment may be used both to increase and to decrease the distances of the vehicles in the vehicle convoy from one another. As an alternative, a situation-dependent optimal distance for the respective on-ramp and/or exit ramp may already be ascertained in the planning of the route or prior to the start of the trip. The situation-dependent optimal distance could subsequently be provided in a retrievable manner. Preferably, each vehicle of the vehicle convoy achieves the previously ascertained situation-dependent optimal distance to the respective on-ramp and/or exit ramp by coasting of the vehicle to achieve a preferably high fuel savings. As an alternative, the distance between the vehicles may be regulated by a deceleration or an acceleration. Regulating the distance by acceleration, however, presupposes that the vehicle convoy uses a lower target speed than is maximally allowed. During the passing of the on-ramp and/or the exit ramp, the ascertained situation-dependent optimal distance between the vehicles is maintained. Should a deviation from the ascertained value occur, the individual vehicles of the group of vehicles may correct their distance by coasting, accelerating or braking. In particular, after having passed an exit ramp or an individual on-ramp and/or an exit ramp having no exit ramp and/or on-ramp following shortly thereafter, a lower number of road users cutting into the vehicle convoy is to be assumed. In this way, a situation-dependent optimal distance between the vehicles may be re-ascertained here. After having passed the end of the acceleration lane or of the deceleration lane, a re-adaptation of the distances according to the re-ascertained situation-dependent optimal distance between the vehicles of the vehicle convoy is carried out.

As a result of the method, safety problems of economically efficient vehicle convoys or groups of vehicles may be eliminated by situationally varying the distances between the vehicles within the group of vehicles. In particular, the problematic passing of on-ramps and/or exit ramps may be solved in that the distances within a platoon or a vehicle convoy are changed in each case for the on-ramps and/or exit ramps, so that safe distances are created for other road users.

Preferably, fixed clearances or distances between the vehicles of the group of vehicles are set, which other road users may use for cutting in. The distances between all vehicles of the vehicle convoy are preferably equally large. As an alternative, the distances between the vehicles of the vehicle convoy may vary, or the distance between multiple vehicles of the group of vehicles driving in succession may be small, before a larger gap for a possible cutting in of a road user follows.

A group of vehicles or vehicle convoy approaching an exit ramp has to start to increase the distances between the vehicles of the vehicle convoy in a timely manner, so that sufficient space is created for cutting-in vehicles. Preferably, the distance at which a distance increasing maneuver is started is established. This would then be the distance which would be necessary at the permissible maximum speed of the vehicle convoy to adapt the distances between the vehicles of the group of vehicles in a timely manner before reaching the on-ramp or the exit ramp. The distance represents a start of a transition segment. At lower speeds, the necessary distance would be smaller. As an alternative, it is also possible to use an explicit speed dependence for ascertaining the optimal distance between the vehicles, and the distance for initiating the adaptation to the optimal situation-dependent distance. The optimal distances for initiating the adaptation to the optimal situation-dependent distance may, for example, be stored in the form of empirical values as calibration data for the vehicles of the vehicle convoy. Such empirical values may alternatively or additionally be statically or dynamically obtained from a cloud or an external server unit and then be buffered in a working memory, for example. The distance at which the regulation of the distances within the vehicle convoy is started may be determined corresponding to the acceleration parameters and the speed difference used.

According to one exemplary embodiment, the situation-dependent optimal distance between the at least two vehicles is increased before passing an on-ramp and/or exit ramp and decreased after having passed the on-ramp or the exit ramp. It may be important here that the adaptation or the increase of the distances is initiated in a timely manner before the on-ramp and/or exit ramp is reached to allow other road users to safely cut in between the vehicles of the vehicle convoy. After the on-ramp and/or exit ramp has been passed, it is advantageous for an economical driving style to reduce the distances between the vehicles of the vehicle convoy as quickly as possible. For this purpose, the vehicles of the vehicle convoy are provided with the optimal distance before and after the respective on-ramp and/or exit ramp to be passed for initiating an adaptation to the situation-dependent optimal distance between the vehicles of the vehicle convoy. This ensures the option of other road users cutting in safely, and additionally makes fuel savings of the vehicles of the vehicle convoy possible on many route sections.

According to one further exemplary embodiment, the adaptation of the situation-dependent optimal distance is automatically initiated by each vehicle of the group of vehicles as a function of the location. In the case of a local coordination, the second vehicle from the front of the vehicle convoy or group of vehicles thus starts to adapt its distance from the first vehicle at the front of the vehicle convoy when it has reached the defined transition segment before the on-ramp and/or exit ramp. For this purpose, for example, it uses a predefined distance progression over time as a target specification, which is set via an adaptive cruise control unit of the respective vehicle. The adaptation of the distance is preferably carried out in a ramp-shaped progression of the distance increase. All vehicles of the vehicle convoy following the second vehicle, which have also reached the established distance before or after the on-ramp and/or the exit ramp for adaptation, also begin to successively regulate their distances from the vehicle driving ahead of them. Optimally, the following vehicles of the vehicle convoy are notified about the adaptation made by the respective vehicle of the vehicle convoy, so that the coordination of the distances takes place in an optimized and cooperative manner.

As an alternative or in addition, the vehicle carrying out an adaptation of the distance next forwards the point in time at which it will presumably reach the distance for initiating the adaptation to the other vehicles of the vehicle convoy, as well as the planned distance progression. Optionally, it may also provide the previously calculated speed progression, which will presumably result from this maneuver. Due to the low data volume, a ramp-shaped distance progression is preferably suitable for the transmission. Only the slope and the end point of the planned distance progression of the vehicle carrying out the adaptation next are needed.

All vehicles of the vehicle convoy following the second vehicle, which is in the process of carrying out an adaptation of its distance from the preceding vehicle of the vehicle convoy, also have to collectively adapt the speed in order to maintain the distances within the vehicle convoy and counteract a systematic reduction of the distances.

Alternatively, it is possible for multiple vehicles to simultaneously initiate an adaptation of the distances between the vehicles if the vehicles use different distances before or after an on-ramp and/or exit ramp at which an initiation of the distances is carried out.

The method allows arbitrarily long vehicle convoys to be created since, if the situation requires, for example in the area of on-ramps and/or exit ramps, it is possible to increase the distances for other road users to cut in and thereafter, when no space requirement exists, to decrease them.

According to one further exemplary embodiment, the setting of the situation-dependent optimal distance between at least two vehicles is coordinated centrally by a first vehicle of the group of vehicles. In the case of a central coordination of the vehicle convoy, the coordination takes place via the vehicle convoy coordinator, for example the first vehicle at the head of the vehicle convoy. The vehicle convoy coordinator has to know all vehicle positions of the respective vehicles of the vehicle convoy and specify at what point the distances are to be increased or decreased, and using which characteristic. The characteristic may be defined, for example, via a chronological progression of the distances or via speed progressions.

According to one further exemplary embodiment, multiple vehicles are spaced apart from one another at an identical situation-dependent optimal distance. The vehicles of the vehicle convoy thus all have the same distance from one another. Depending on the type of the respective on-ramp and/or exit ramp, the distance may be different in size. For example, the distance between the vehicles of the vehicle convoy may be larger when passing a short acceleration lane of an on-ramp than in the case of an on-ramp which has a long acceleration lane, in order to increase the safety.

According to one further exemplary embodiment, multiple vehicles are arranged into at least two vehicle groups, and the distance between the formed vehicle groups is optimally adapted as a function of the situation. The distances between the vehicles of the vehicle convoy may be uniformly increased, or a group within the vehicle convoy may be created. For example, 2 or 3 vehicles form a vehicle group. In this case, larger distances are maintained between the blocks or groups, while a smaller distance is maintained within the vehicle group. The distance between the vehicle groups may possibly be larger in the area of on-ramps and/or exit ramps than the distance between the group on a stretch of the route having no on-ramps and/or exit ramps.

According to one further exemplary embodiment, the size of the vehicle group is set as a function of the respective on-ramp and/or exit ramp. The respective different on-ramps and/or exit ramps may require different situation-dependent optimal distances between the vehicle groups. In the case of heavily frequented on-ramps and/or exit ramps, it may be necessary to divide vehicle groups of three or more vehicles into smaller groups of two vehicles, for example, by varying the distances between the vehicles. This makes it possible to leave a larger number of gaps open within the vehicle group, for example to allow a larger number of road users to cut in.

According to one further exemplary embodiment, the on-ramps and/or exit ramps are ascertained via a navigation system or an infrastructure. In this way, for example, the on-ramps and/or exit ramps may already be identified prior to the start of the trip or when planning the route with the aid of a navigation device. Different vehicle convoy patterns, for example in groups of 2 or 3, and situation-dependent optimal distances may be ascertained for the different on-ramps and exit ramps. Moreover, with an established distance before and after the on-ramps and/or exit ramps, the position for the timely initiation of the adaptation of the distances may be ascertained. For example, the safety may thus be additionally increased when passing short acceleration lanes.

According to one further exemplary embodiment, geographical data are taken into consideration in the adaptation of the situation-dependent optimal distance between at least two vehicles. For example, topographical circumstances may be taken into consideration in the ascertainment of situation-dependent optimal distances or the establishment of the distance for the initiation of an adaptation of the distances before and after on-ramps and/or exit ramps. In the case of a downhill grade, for example, the adaptation of the distances may be started earlier since an energy-optimized coasting requires a longer time period for reducing the speed. Analogously, a reduction of the speed may be started later in the case of an uphill grade. The distance at which the adaptation of the distances is initiated is optimal when the increased distance is achieved in an energy-optimized manner, for example as a result of coasting, including uncertainties in the distance setting, with a predefined distance or transition segment before the exit ramp.

According to one further exemplary embodiment, a traffic volume is taken into consideration in the adaptation of the situation-dependent optimal distance between at least two vehicles. For this purpose, a gap may be formed as needed. For this purpose, the need for larger distances between the vehicles of the vehicle convoy for other road users to cut in may be detected with the aid of an infrastructure via the number and type of vehicles desiring to enter or exit. This information may be distributed by the infrastructure to road users, for example, via a Car-to-Infrastructure connection with the aid of WLAN or UMTS. Furthermore, statistical data, such as the customary traffic volume on the route sections at certain times, may be included in the planning. Via a need-based gap formation, however, the offering may also be reduced by maintaining a minimum offering of necessary larger distances from other road users.

According to one further specific embodiment, the situation-dependent optimal distance before and after the passing of exit ramps and/or on-ramps between at least two vehicles is retrieved from an external server unit or from an internal vehicle memory. Preferably, the situation-dependent optimal distances have to be ascertained only once for each on-ramp and/or exit ramp. Thereafter, the data are uploaded onto an external server unit via a data link and may be queried by all vehicles via an existing data link. Any specific distance at which an adaptation of the distances between the vehicles of the vehicle convoy is initiated may also be stored for each of the on-ramps and/or exit ramps on the external server unit.

As an alternative, each vehicle may be equipped with a vehicle memory, on which the specific distance at which an adaptation of the distances between the vehicles of the vehicle convoy is initiated are stored or saved for each of the on-ramps and/or exit ramps. In addition, an exchange between the vehicle memory and the external server unit is also possible.

According to one further exemplary embodiment, the respective situation-dependent optimal distance between the vehicles of the group of vehicles is set collectively. The distances between the vehicles of the vehicle convoy are regulated simultaneously until the situation-dependent optimal distance has been achieved. This allows the distances between the vehicles of the vehicle convoy to be adapted quickly within a shorter route section.

According to one further exemplary embodiment, the respective situation-dependent optimal distance between at least two vehicles is adapted or maintained as a function of a distance from a further on-ramp and/or exit ramp. For example, if a succession of multiple on-ramps and exit ramps within a short distance is ascertained, the distance between the vehicles of the vehicle convoy may remain increased over a longer segment, even if a potential reduction of the distances would generally be possible. In the case of a single on-ramp, the situation-dependent optimal distance may be re-ascertained directly after the on-ramp has been passed, and an adaptation may be carried out. Furthermore, it may be useful to set the distance control within a vehicle convoy in a timely manner before an on-ramp and/or exit ramp is reached, since larger vehicle convoys require a longer segment in which the distance increase can take place.

As a result of the method, the distance from the on-ramp and/or exit ramp at which an increased distance is no longer necessary may be determined. This size is essentially dependent on the type of the on-ramp or exit ramp. In the case of a combined on-ramp/exit ramp, this is possible at the end of the acceleration lane. This position may either be read out from electronic maps or be assumed across the board as a fixed distance after an exit ramp.

Preferred exemplary embodiments of the present invention are described in greater detail below based on highly simplified schematic representations.

### BRIEF DESCRIPTION OF THE DRAWINGS

FIG. 1 shows a flow chart of a method according to a first exemplary embodiment.

FIG. 2 shows a schematic representation of a vehicle convoy which uses the method according to the first exemplary embodiment.

### DETAILED DESCRIPTION OF EXAMPLE EMBODIMENTS

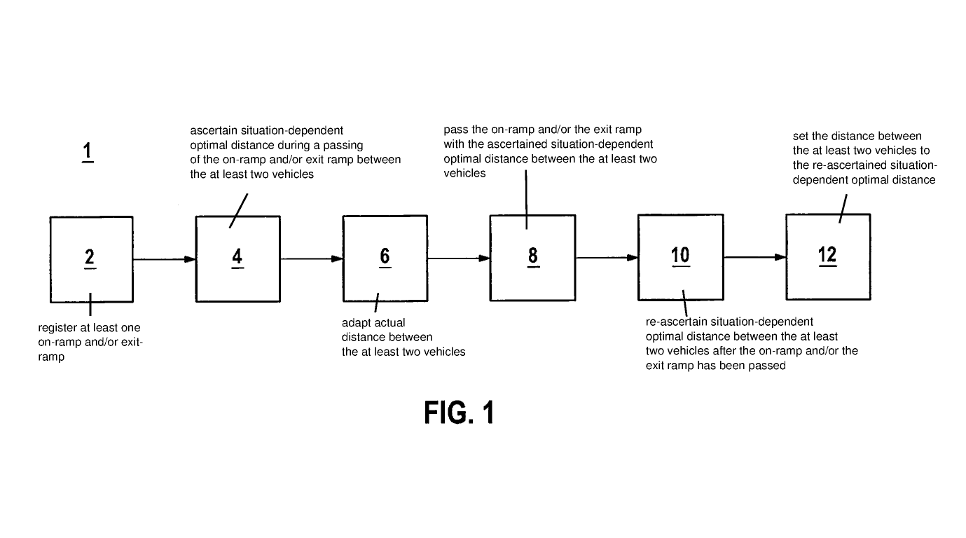

FIG. 1 shows a flow chart of a method 1 for coordinating at least one distance between at least two autonomous or semi-autonomous vehicles in a group of vehicles or a vehicle convoy according to a first exemplary embodiment.

In a first step, at least one on-ramp and/or exit ramp of a road traveled by the at least two vehicles in an area ahead of the group of vehicles is registered 2.

Thereafter, a situation-dependent optimal distance during a passing of the on-ramp and/or exit ramp between the at least two vehicles is ascertained 4.

The actual distance between the at least two vehicles is adapted 6 to the situation-dependent optimal distance before the on-ramp and/or the exit ramp is reached.

In a further step, the on-ramp and/or the exit ramp is/are passed 8 with the ascertained situation-dependent optimal distance between the at least two vehicles.

After the on-ramp and/or exit ramp has/have been passed, a situation-dependent optimal distance between the at least two vehicles is re-ascertained 10.

Thereafter, the distance between the at least two vehicles is set 12 to the re-ascertained situation-dependent optimal distance between the at least two vehicles after having passed the on-ramp and/or the exit ramp.

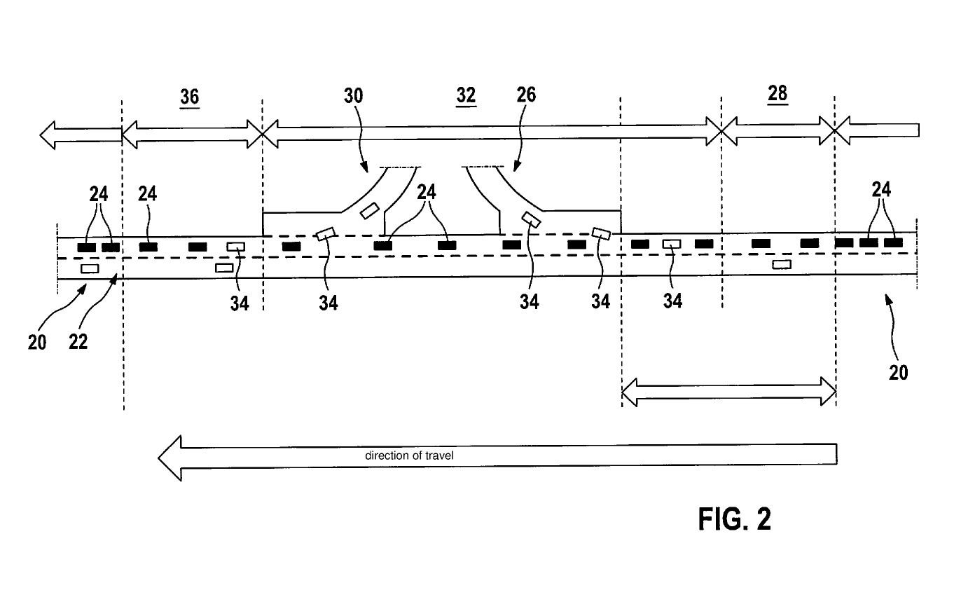

FIG. 2 shows a schematic representation of a vehicle convoy 20 or of a group of vehicles 20, which uses method 1 according to the first exemplary embodiment. Vehicle convoy 20 is traveling on road 22 and is made up of multiple vehicles 24. Before an exit ramp 26, vehicle convoy 20 has a regular distance between vehicles 24.

The exit ramp is registered 2 by vehicle convoy 20, and an optimal distance between vehicles 24 of vehicle convoy 20 for passing exit ramp 26 is ascertained 4. Just before exit ramp 26, a transition segment 28 is provided in which vehicles 24 adapt 6 their distance from one another.

Since vehicles 24 have registered 2 an on-ramp 30 on road 22 which is situated immediately after exit ramp 26, vehicles 24 maintain their set larger distance from one another during entire segment 32 when passing exit ramp 26 and on-ramp 30. By increasing the distance between vehicles 24 of group of vehicles 20, other road users 34 may merge between vehicles 24 and exit road 22 or enter the road.

After having passed on-ramp 30, vehicles 24 on a further transition segment 36 begin to adapt 12 their distance again. After having passed transition segment 36, vehicles 24 of group of vehicles 20 again have a regular distance with respect to one another.

What is claimed is:

1. A method for coordinating at least one distance between at least two autonomous or semi-autonomous vehicles in a group of vehicles, comprising:
registering at least one on-ramp and/or exit ramp of a road traveled by the at least two vehicles in an area ahead of the group of vehicles;
ascertaining a situation-dependent optimal distance for passing the on-ramp and/or exit ramp between the at least two vehicles;
adapting a distance between the at least two vehicles until the situation-dependent optimal distance between the at least two vehicles is reached before the on-ramp and/or the exit ramp is reached;
passing the on-ramp and/or the exit ramp with the ascertained situation-dependent optimal distance between the at least two vehicles;
re-ascertaining a situation-dependent optimal distance between the at least two vehicles for a segment after having passed the on-ramp and/or exit ramp; and
re-adapting the distance between the at least two vehicles until the re-ascertained situation-dependent optimal distance between the at least two vehicles is reached after the on-ramp and/or the exit ramp has been passed.

2. The method as recited in claim 1, wherein the situation-dependent optimal distance between at least two vehicles is increased before passing an on-ramp and/or exit ramp and decreased after having passed the on-ramp and/or exit ramp.

3. The method as recited in claim 1, wherein the adaptation of the situation-dependent optimal distance is automatically initiated by each vehicle of the group of vehicles as a function of location.

4. The method as recited in claim 1, wherein the setting of the ascertained situation-dependent optimal distance between the at least two vehicles is coordinated centrally by a vehicle of the group of vehicles.

5. The method as recited in claim 1, wherein multiple vehicles are spaced apart from one another at an identical situation-dependent optimal distance.

6. The method as recited in claim 1, wherein multiple vehicles are arranged into at least two vehicle groups, and a distance between the formed vehicle groups is adapted as a function of the situation.

7. The method as recited in claim 6, wherein a size of the vehicle group is set as a function of the respective on-ramp and/or exit ramp.

8. The method as recited in claim 1, wherein the on-ramp and/or exit ramp is ascertained via a navigation system or an infrastructure.

9. The method as recited in claim 1, wherein geographical data are taken into consideration in the adaptation of the situation-dependent optimal distance between at least two vehicles.

10. The method as recited in claim 1, wherein a traffic volume is taken into consideration in the adaptation of the situation-dependent optimal distance between at least two vehicles.

11. The method as recited in claim 1, wherein the situation-dependent optimal distance before and after passing on-ramps and/or exit ramps between at least two vehicles is retrieved from an external server unit or from an internal vehicle memory.

12. The method as recited in claim 1, wherein respective situation-dependent optimal distance between the vehicles of the group of vehicles is set collectively.

13. The method as recited in claim 1, wherein respective situation-dependent optimal distance between at least two vehicles after having passed the on-ramp and/or exit ramp is adapted or maintained as a function of a distance from a further on-ramp and/or exit ramp.
